(19) United States
(12) Patent Application Publication
(10) Pub. No.: US 2025/0256423 A1
(43) Pub. Date: Aug. 14, 2025

(54) CUTTING CONTROL METHOD, CUTTING DEVICE AND STORAGE MEDIUM

(71) Applicant: CASIO COMPUTER CO., LTD., Tokyo (JP)

(72) Inventor: Syuichi YAMASAKI, Tokyo (JP)

(73) Assignee: CASIO COMPUTER CO., LTD., Tokyo (JP)

(21) Appl. No.: 19/047,849

(22) Filed: Feb. 7, 2025

(30) Foreign Application Priority Data
Feb. 14, 2024 (JP) 2024-019887
Feb. 14, 2024 (JP) 2024-019895

(51) Int. Cl. B26F 1/38; B26D 5/08

(52) U.S. Cl. CPC B26F 1/3813; B26D 5/08; B26F 2210/02

(57) ABSTRACT

Disclosed is a cutting control method that is performed by a cutting device including a cutter that cuts a cutting target medium with a cutter blade based on predetermined design information. The cutting control method includes, in response to the design information including unnecessary region information indicating an unnecessary region to be removed after a first cutting in which the cutter blade cuts the cutting target medium based on the predetermined design information, controlling the cutter to perform special cutting inside the unnecessary region. The special cutting is performed with a second cutting method different from a first cutting method in which the cutter blade is moved to perform the first cutting.

### CROSS-REFERENCE TO RELATED APPLICATIONS

This application is based upon and claims the benefit of priority from the prior Japanese Patent Applications No. 2024-019887 and No. 2024-019895, both filed on Feb. 14, 2024, the entire contents of which are incorporated herein by reference.

### TECHNICAL FIELD

The present disclosure relates to a cutting control method, a cutting device and a storage medium.

### DESCRIPTION OF RELATED ART

There has been known a cutting device that cuts a medium to be cut. Regarding this cutting device, for example, JP 2007-98505 A discloses an adhesive sheet forming device that cuts on the perimeter of a cut region and cuts out an unnecessary region inside the cut region.

### SUMMARY OF THE INVENTION

According to an aspect of the present disclosure, there is provided a cutting control method that is performed by a cutting device including a cutter that cuts a cutting target medium with a cutter blade based on predetermined design information, the cutting control method including:
in response to the design information including unnecessary region information indicating an unnecessary region to be removed after a first cutting in which the cutter blade cuts the cutting target medium based on the predetermined design information, controlling the cutter to perform special cutting inside the unnecessary region,
wherein the special cutting is performed with a second cutting method different from a first cutting method in which the cutter blade is moved to perform the first cutting.

### BRIEF DESCRIPTION OF DRAWINGS

FIG. 1 is a block diagram illustrating a cutting system according to an embodiment(s) of the present disclosure.

FIG. 2 is a block diagram illustrating a functional configuration of a cutting device.

FIG. 3 is a perspective view illustrating a placement plate on which a mount with a sheet of paper attached is placed.

FIG. 4 is a block diagram illustrating a functional configuration of a terminal device.

FIG. 5 is a flowchart illustrating a control procedure for a waste removal cutting process.

FIG. 6 illustrates an example of waste removal cutting.

FIG. 7A illustrates a section of the sheet during the waste removal cutting.

FIG. 7B illustrates movement of a cutter blade during the waste removal cutting.

FIG. 8 illustrates a setting method of a waste removal cutting width and a waste removal cutting length.

FIG. 9 illustrates a setting method of the waste removal cutting width and the waste removal cutting length.

FIG. 10 illustrates an example of the waste removal cutting.

FIG. 11A illustrates an example of the waste removal cutting.

FIG. 11B illustrates an example of the waste removal cutting.

FIG. 11C illustrates an example of the waste removal cutting.

FIG. 11D illustrates an example of the waste removal cutting.

FIG. 12 is a flowchart illustrating a control procedure for a cutting data generating process.

FIG. 13 illustrates an example of a necessity selection receiving screen.

FIG. 14A illustrates an example of the necessity selection receiving screen.

FIG. 14B illustrates an example of the necessity selection receiving screen.

FIG. 14C illustrates an example of the necessity selection receiving screen.

FIG. 14D illustrates an example of the necessity selection receiving screen.

FIG. 15A illustrates an example of the necessity selection receiving screen.

FIG. 15B illustrates an example of the necessity selection receiving screen.

FIG. 15C illustrates examples of a symbol mark.

FIG. 15D illustrates an example of the necessity selection receiving screen.

FIG. 16 is a flowchart illustrating a control procedure for the waste removal cutting process according to a modification.

### DETAILED DESCRIPTION

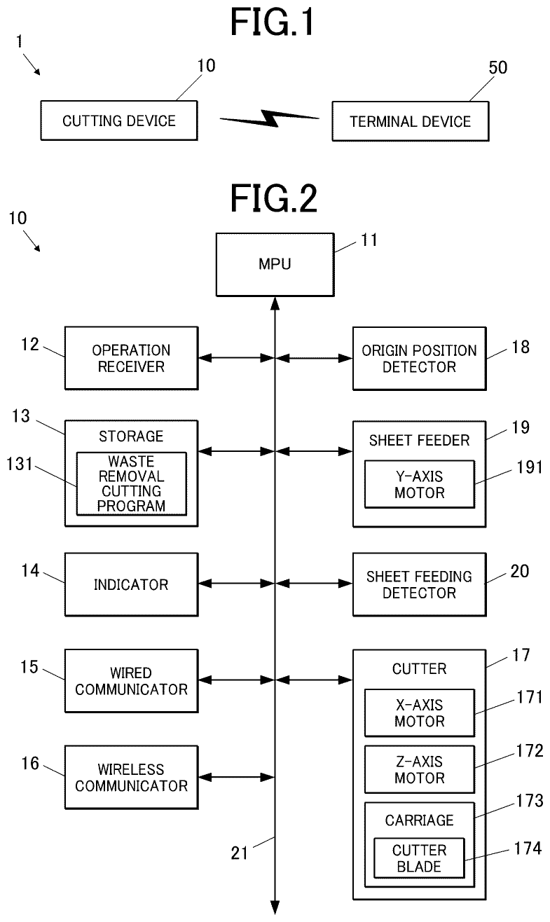

Hereinafter, one or more embodiments of the present disclosure will be described in detail with reference to the drawings. However, the scope of the present disclosure is not limited to the embodiments or illustrated examples. As illustrated in FIG. 1, a cutting system 1 of an embodiment(s) includes a cutting device 10 and a terminal device 50.

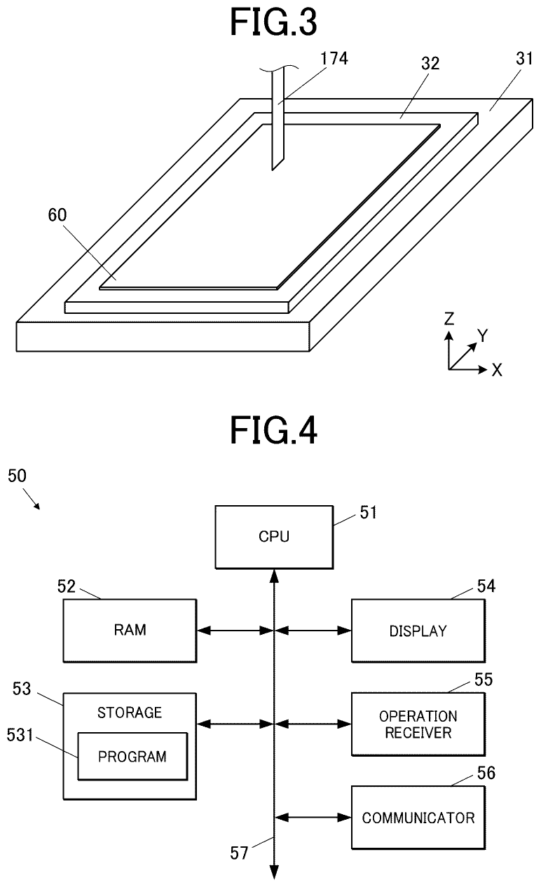

The cutting device 10 is a device that cuts a planar medium, for example, a rectangular medium, to be cut (cutting target medium) attached to a mount 32 (described later) placed (set) on a placement plate 31 (described later) into any planar shape. In this embodiment, the cutting target medium is a sheet 60 of A4 size paper (in FIG. 3), but not limited thereto. The cutting target medium may be another medium that can be cut with a cutter blade, such as a resin sheet, a sticker (seal) or leather.

The terminal device (cutting data generating device) 50 is a personal computer (PC) or a server that generates/edits cutting data indicating a planar shape, a position and so forth for the cutting device 10 to perform cutting. In addition to this, the terminal device 50 receives inputs of operation information related to the cutting device 10, displays display information related to the cutting device 10, and so forth. The terminal device 50 is used in a state of being communicatively connected with the cutting device 10 by wireless communication.

The terminal device 50 communicatively connected with the cutting device 10 is not limited to a PC, but may be another terminal device, such as a smartphone or a tablet PC. In this embodiment, the communication method of the wireless communication between the cutting device 10 and the terminal device 50 is Bluetooth®, but not limited thereto. The communication method of the wireless communication may be another communication method, such as Wi-Fi®. The communication connection between the cutting device 10 and the terminal device 50 is not limited to wireless communication, but may be wired communication. The wired communication is, for example, a universal serial bus (USB) communication via a communication cable.

As illustrated in FIG. 2, the cutting device 10 includes a micro processing unit (MPU) 11 as a controller (processor), an operation receiver 12, a storage 13, an indicator 14, a wired communicator 15, a wireless communicator 16, a cutter 17, an origin position detector 18, a sheet feeder 19, and a sheet feeding detector 20. These components of the cutting device 10 are connected with one another via a bus 21.

The MPU 11 controls the components of the cutting device 10. The MPU 11 includes a central processing unit (CPU) and a random access memory (RAM). The CPU reads a specified program among various programs stored in the storage 13, loads the specified program to the RAM, and performs a process among various processes in cooperation with the loaded program. The RAM is a volatile semiconductor memory and forms a work area where various data and programs are stored temporarily. The operation receiver 12 has various buttons, and receives press inputs made by a user onto the buttons and outputs pieces of operation information corresponding to the inputs to the MPU 11. The various buttons of the operation receiver 12 include a position key to move the position of the sheet 60, a button to pause cutting, a button to set the sheet 60, and a button to remove the sheet 60.

The storage 13 is an information readable-and-writable storage (non-transitory computer-readable storage medium), such as a flash memory. The storage 13 stores various data, such as cutting data mentioned above, and various programs. The storage 13 stores a waste removal cutting program 131 to perform a waste removal cutting process described later. The indicator 14 includes a light emitter, such as a light emitting diode (LED), and indicates various states of the cutting device 10 by lighting and no-lighting. The indicator 14 includes, for example, a power lamp that indicates power-on and power-off. The indicator 14 causes the light emitter to emit light or not to emit light in accordance with an instruction from the MPU 11.

The wired communicator 15 is an interface for wired communication conforming to a communication standard such as USB. The MPU 11 transmits and receives information to and from external devices, such as the terminal device 50, via the wired communicator 15 and a communication cable. The wireless communicator 16 includes an antenna, a modulation-and-demodulation circuit and a signal processing circuit, and is an interface for Bluetooth communication with external devices, such as the terminal device 50. The MPU 11 transmits and receives information to and from external devices, such as the terminal device 50, via the wireless communicator 16.

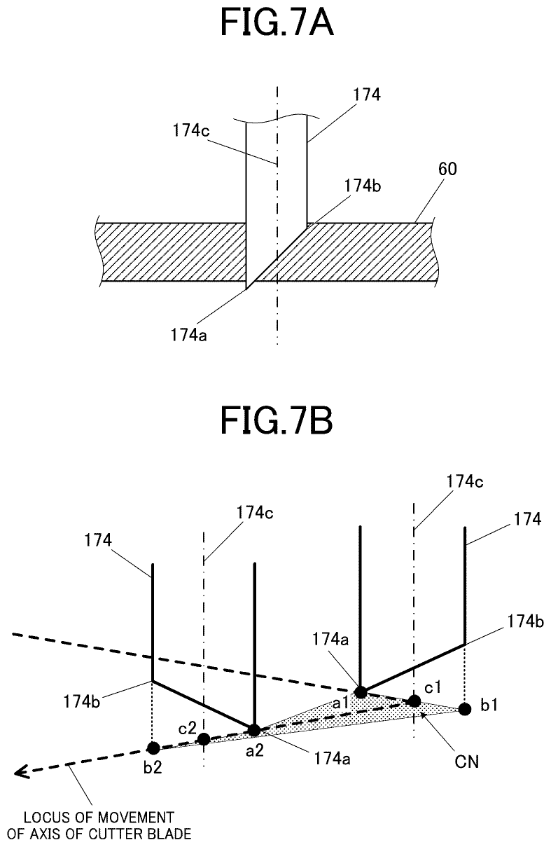

The cutter 17 includes an X-axis motor 171, a Z-axis motor 172, a carriage 173, and a cutter blade 174. The cutter 17 moves the cutter blade 174 mounted on the carriage 173 in the X-axis direction and the Z-axis direction by driving the X-axis motor 171 and the Z-axis motor 172 in accordance with instructions from the MPU 11. By moving the cutter blade 174, the cutter 17 cuts the sheet 60 attached to the mount 32 placed (set) on the placement plate 31 into any planer shape. The cutter blade 174 is mounted on the carriage 173 in a state in which the cutter blade 174 is freely rotatable on an axis (drive axis) 174c (in FIG. 7A). That is, the edge 174a (in FIG. 7A) of the cutter blade 174 is designed to face a cutting direction when the sheet 60 (cutting target medium) is cut. The edge 174a of the cutter blade 174 can be made to face a desired direction (e.g., cutting direction) by driving the carriage 173 and/or the sheet feeder 19 in a state in which the tip (edge 174a) of the cutter blade 174 is slightly in contact with the sheet 60. Hereinafter, the sheet 60 attached to the mount 32 placed on the placement plate 31, the X-axis, the Y-axis and the Z-axis will be described with reference to FIG. 3.

The mount 32 is used in order to, for example, prevent the cutter blade 174 from damaging the placement plate 31 and to place the sheet 60 at a correct position. The mount 32 has a planar rectangular shape. Since the mount 32 is placed on the placement plate 31, the mount 32 has a shape that fits with the planar shape of the placement plate 31. The mount 32 is made of a soft material that does not damage the cutter blade 174 when the sheet 60 is cut. An adhesive is applied to the upper face of the mount 32 for the sheet 60 to be attached thereto. On the placement plate 31, the mount 32 with the sheet 60 attached is placed. The X-axis corresponds to a main-scanning direction in a case where the placement plate 31 (mount 32 and sheet 60) is conveyed. The Y-axis is perpendicular to the X-axis and is a conveyance direction (sheet feeding direction or sub-scanning direction) in which the placement plate 31 (mount 32 and sheet 60) is conveyed. The Z-axis is perpendicular to the XY plane and is a direction in which the cutter blade 174 moves up and down with respect to the sheet 60.

Returning to FIG. 2, the X-axis motor 171 is a motor that drives the carriage 173 in the X-axis direction in accordance with an instruction from the MPU 11. The Z-axis motor 172 is a motor that drives the cutter blade 174 in the Z-axis direction in accordance with an instruction from the MPU 11. The carriage 173 is a movable component that is movable in the X-axis direction and provided with the cutter blade 174. The cutter blade 174 is a cutting instrument made of a conductive material, such as metal, to cut the sheet 60, and has, for example, an oblique edge (edge 174a) at its tip.

The origin position detector 18 is a position detector, such as an optical sensor, that detects in accordance with an instruction from the MPU 11 whether the cutter blade 174 is at the position of the origin in the X-axis direction. The origin position detector 18 outputs the detection result of whether the cutter blade 174 is at the position of the origin to the MPU 11. The MPU 11 controls the position of the cutter blade 174 of the cutter 17 in the X-axis direction, using the detection result of whether the cutter blade 174 is at the position of the origin.

The sheet feeder 19 includes a Y-axis motor 191. The sheet feeder 19 is a conveyor that conveys, in the Y-axis direction, the placement plate 31 on which the mount 32 with the sheet 60 attached is placed by driving the Y-axis motor 191 in accordance with an instruction from the MPU 11. The sheet feeding detector 20 is a detector, such as an optical sensor, that detects in accordance with an instruction from the MPU 11 whether the placement plate 31, on which the mount 32 with the sheet 60 attached is placed, is fed (set) into a sheet feeding port of the sheet feeder 19. The sheet feeding detector 20 outputs, to the MPU 11, the detection result of whether the sheet 60 is set.

As illustrated in FIG. 4, the terminal device 50 includes a CPU 51, a RAM 52, a storage 53, a display 54, an operation receiver 55, and a communicator 56. These components of the terminal device 50 are connected with one another via a bus 57. The CPU 51 is a processor that reads and executes programs 531 stored in the storage 53 to perform various types of arithmetic processing, thereby controlling operation of each component of the terminal device 50. The RAM 52 provides a working memory space for the CPU 51 and stores temporary data. The storage 53 is a non-transitory storage medium readable by the CPU 51 as a computer, and stores the programs 531 and various data (e.g., cutting data).

The display 54 is configured by a liquid crystal display (LCD), an electro luminescence (EL) display or the like, and performs various types of display in accordance with pieces of display information (display instructions) from the CPU 51. The operation receiver 55 includes a key inputter, such as a keyboard, and a pointing device, such as a mouse, and receives inputs of key operations and position operations made by a user and outputs pieces of operation information corresponding to the inputs to the CPU 51. The CPU 51 receives the inputs of the operations made by the user on the basis of the pieces of operation information transmitted from the operation receiver 55. The communicator 56 is, for example, a communicator employing a wireless standard, such as Bluetooth, or a wired communicator, such as a USB terminal.

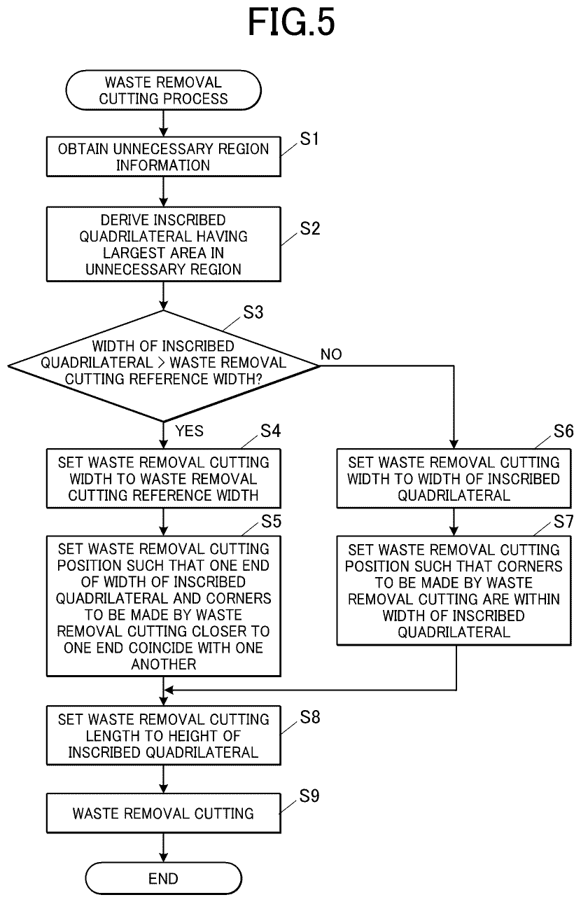

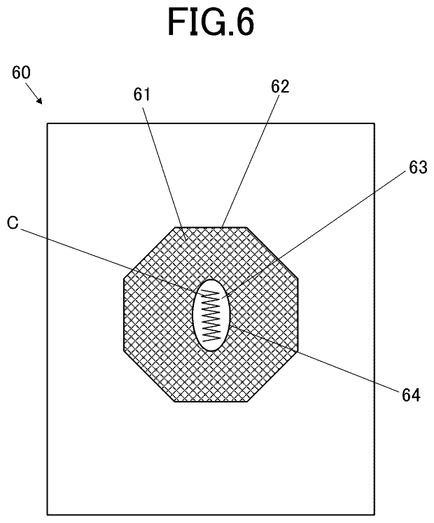

The cutting device 10 performs waste removal cutting in the waste removal cutting process (in FIG. 5). This waste removal cutting (special cutting) makes it easy to identify an unnecessary region(s) (waste region(s)) of the sheet 60 having been cut into a shape, and brings about, what is called, turned-up (which generates curls) that makes it easy to remove the unnecessary region. In the aforementioned adhesive sheet forming device disclosed by JP 2007-98505 A, if shapes of unnecessary regions inside a cut region(s) are various, a removing device (extrusion device) cannot be used to remove the unnecessary regions. In such a case, the unnecessary regions inside the cut region(s) need to be removed manually, which may be time-consuming and damage necessary regions. Therefore, in the present disclosure, in order to easily and smoothly remove unnecessary regions inside cut regions, the waste removal cutting is performed. Hereinafter, a mode of the waste removal cutting will be described with reference to FIG. 6.

As illustrated in FIG. 6, the sheet 60 is cut on (along) a perimeter 62 (cut line) of a necessary region 61 the contour of which forms an octagonal shape, and also cut on a perimeter 64 (cut line) of an unnecessary region 63 having a vertically elongated oval shape inside the necessary region 61. Inside the unnecessary region 63, the aforementioned waste removal cutting is performed, so that a zigzag cut C is formed. In other words, a wedge-shaped (V-shaped) cut is made multiple times. This cut C is formed by driving the cutter blade 174 zigzag. At the time, the edge 174a of the cutter blade 174 does not follow movement of the axis 174c of the cutter blade 174. Therefore, disorder of the sheet 60, such as the sheet 60 being turned-up, occurs at corners (tops of mountain shapes) of the cut C. Hereinafter, movement of the cutter blade 174 during the waste removal cutting will be described with reference to FIG. 7A and FIG. 7B.

As illustrated in FIG. 7A, during the waste removal cutting, the cutter blade 174 is set such that the edge 174a of the cutter blade 174 pierces the sheet 60 whereas the base 174b of the cutter blade 174 does not pierce the sheet 60. As illustrated in FIG. 7B, during the waste removal cutting, when the axis 174c (drive axis) of the cutter blade 174 reaches a corner CN, the axis 174c is at the position of c1, the edge 174a is at the position of a1, and the base 174b is at the position of b1. When the axis 174c moves from the position of c1 to the position of c2 so as to draw a wedge-shaped (V-shaped) locus, the edge 174a moves to the position of a2 and the base 174b moves to the position of b2 in FIG. 7B. Since the cutter blade 174 is inserted in the sheet 60 from the edge 174a to the base 174b, when the edge 174a moves from the position of a1 to the position of a2 and the base 174b moves from the position of b1 to the position of b2 in this state, the edge 174a and the base 174b do not follow the movement of the axis 174c, and the sheet 60 being turned-up occurs at or near the region surrounded by the positions of a1, b1, a2 and b2. Thus, when the waste removal cutting is performed, the wedge-shaped (V-shaped) movement of the axis 174c of the cutter blade 174 is repeated, so that the turned-up occurs in an unnecessary region (e.g., unnecessary region 63 in FIG. 6) collectively. Since the turned-up makes the unnecessary region conspicuous, the unnecessary region can be easily identified. Further, by picking up the curls, which are generated by the turned-up, with tweezers or the like or by making the curls stand up with a finger, the unnecessary region can be easily and smoothly removed.

Returning to FIG. 5, when the waste removal cutting process is started, first, the MPU 11 obtains unnecessary region information indicating the shape and the position of an/each unnecessary region (waste region) from cutting data (Step S1). It is assumed that in order to perform the waste removal cutting process, a cutting process (contour cutting process) has been performed in advance. The cutting process is a process for cutting out a necessary region (e.g., necessary region 61 in FIG. 6) and an unnecessary region (e.g., unnecessary region 63 in FIG. 6) on the basis of cutting data (design information) indicating the shapes and the positions of the necessary region and the unnecessary region.

Next, the MPU 11 derives the inscribed quadrilateral A having the largest area in the unnecessary region on the basis of the unnecessary region information obtained in Step S1 (Step S2). If there are two or more unnecessary regions, in Step S2, the MPU 11 derives, for each unnecessary region, the inscribed quadrangle A having the largest area in the unnecessary region. Then, the MPU 11 performs, for each unnecessary region, processes of Step S3 and the subsequent steps. In this embodiment, as illustrated in FIG. 8 and FIG. 9, the inscribed quadrilateral A is rectangular, but may be trapezoidal, parallelogrammatic or rhombic. In this embodiment, of the two pairs of sides of the derived inscribed quadrilateral A, the length of the pair of shorter sides is defined as a width WA, and the length of the pair of longer sides is defined as a height HA. Since the inscribed quadrilateral A is derived on the basis of the unnecessary region information, namely, depends on the shape of the unnecessary region, directions of the width WA and the height HA of the inscribed quadrilateral A each are not necessarily along the X-axis direction or the Y-axis direction of the cutting device 10. It is noted that if the inscribed quadrilateral A to be derived is square, the inscribed quadrilateral A is derived such that one pair of sides is parallel to the X-axis direction and the other pair of sides is parallel to the Y-axis direction, for example. Then, the length of the pair of sides parallel to the X-axis direction is defined as the width WA, and the length of the pair of sides parallel to the Y-axis direction is defined as the height HA.

Next, the MPU 11 determines whether the width WA (in FIG. 8 and FIG. 9) of the inscribed quadrilateral A derived in Step S2 is greater than a waste removal cutting reference width (Step S3). The waste removal cutting reference width is a default value of a waste removal cutting width and set to a predetermined dimension (approximately 1 mm to 3 mm). As illustrated in FIG. 8, the waste removal cutting width indicates the length of a stroke of the axis 174c of the cutter blade 174 from one corner CN1 of the zigzag cut C to the next corner CN2 that is continuous with the one corner CN1. Further, a waste removal cutting angle is the angle of corners of the cut C and set to a predetermined angle (90 degrees or less). Still further, a waste removal cutting length indicates the length of the cut C in a direction perpendicular to the direction of the waste removal cutting width.

In Step S3, if the MPU 11 determines that the

width WA of the inscribed quadrilateral A is greater than the waste removal cutting reference width (Step S3; YES), the MPU 11 sets the waste removal cutting width to the waste removal cutting reference width as illustrated in FIG. 8 (Step S4). Next, the MPU 11 sets a waste removal cutting position such that one end (e.g., left end in FIG. 8) of the width WA of the inscribed quadrilateral A and corners to be made by the waste removal cutting (corners of the cut C) closer to the one end (e.g., left end in FIG. 8) coincide with one another (Step S5). The waste removal cutting width may be set to the width WA of the inscribed quadrilateral A when the width WA of the inscribed quadrilateral A is greater than the waste removal cutting reference width. However, the turned-up occurs only at corners made by the waste removal cutting (corners of the cut C). It is preferable to shorten time required for the waste removal cutting by reducing or eliminating time taken by cutting parts other than the corners, which are made by the waste removal cutting. Therefore, when the width WA of the inscribed quadrilateral A is greater than the waste removal cutting reference width, the waste removal cutting width is set to the waste removal cutting reference width. This can prevent the time required for the waste removal cutting from being lengthened. Further, by setting the waste removal cutting position at or near one end of the width WA of the inscribed quadrilateral A, the turned-up can be made to occur at or near an end of the unnecessary region 63. This can make it easier to remove the unnecessary region 63 as compared with a case where the turned-up is made to occur at the center of the unnecessary region 63. In Step S5, the waste removal cutting position may be set such that the other end (e.g., right end in FIG. 8) of the width WA of the inscribed quadrilateral A and corners to be made by the waste removal cutting (corners of the cut C) closer to the other end (e.g., right end in FIG. 8) coincide with one another. Further, although in Step S5, the waste removal cutting position is set such that one end of the width WA of the inscribed quadrilateral A and the corners to be made by the waste removal cutting (corners of the cut C) closer to the one end coincide with one another, the waste removal cutting position may be set such that the corners to be made by the waste removal cutting closer to the one end are spaced about 0.5 mm inward from the one end.

Next, the MPU 11 sets the waste removal cutting length to the height HA of the inscribed quadrilateral A as illustrated in FIG. 8 (Step S8). The waste removal cutting length is not necessarily set to the height HA of the inscribed quadrilateral A. For example, if the value of the height HA (length) of the inscribed quadrilateral A is equal to or greater than a predetermined value that is the minimum required for the waste removal cutting, the waste removal cutting length may be set to the predetermined value. This predetermined value is, for example, a value equivalent to the waste removal cutting length of one to ten corners made by the waste removal cutting.

Next, the MPU 11 adds a cut line (design) for the special cutting to the cutting data on the basis of the waste removal cutting width set in Step S4, the waste removal cutting position set in Step S5, and the waste removal cutting length set in Step S8, and causes the cutter 17 to perform the waste removal cutting (Step S9). Then, the MPU 11 ends the waste removal cutting process.

In Step S3, if the MPU 11 determines that the width WA of the inscribed quadrilateral A is not greater than the waste removal cutting reference width (Step S3; NO), the MPU 11 sets the waste removal cutting width to the width WA of the inscribed quadrilateral A (Step S6) as illustrated in FIG. 9. Next, the MPU 11 sets the waste removal cutting position such that corners to be made by the waste removal cutting (corners of the cut C) are within the width WA of the inscribed quadrilateral A (Step S7). Next, the MPU 11 sets the waste removal cutting length to the height HA of the inscribed quadrilateral A (Step S8). The waste removal cutting length is not necessarily set to the height HA of the inscribed quadrilateral A when the width WA of the inscribed quadrilateral A is not greater than the waste removal cutting reference width too. For example, if the value of the height HA (length) of the inscribed quadrilateral A is equal to or greater than a predetermined value that is the minimum required for the waste removal cutting, the waste removal cutting length may be set to the predetermined value.

Next, the MPU 11 adds a cut line (design) for the special cutting to the cutting data on the basis of the waste removal cutting width set in Step S6, the waste removal cutting position set in Step S7, and the waste removal cutting length set in Step S8, and causes the cutter 17 to perform the waste removal cutting (Step S9). Then, the MPU 11 ends the waste removal cutting process.

As described above, according to this embodiment, the cutting device 10 includes the MPU 11 (processor) and the cutter 17 that cuts the sheet 60 (cutting target medium) on the basis of cutting data (predetermined design information) as first cutting. If the cutting data (predetermined design information) includes unnecessary region information indicating an unnecessary region(s) to be removed after the first cutting, the MPU 11 controls the cutter 17 to perform the waste removal cutting (special cutting), which brings about the turned-up, inside the unnecessary region. Since the waste removal cutting, which brings about the turned-up, is performed inside the unnecessary region, the unnecessary region can be easily and smoothly removed by pinching the curls, which are generated by the turned-up, with tweezers or the like or by making the curls stand up with a finger. Further, since the unnecessary region becomes conspicuous due to the turned-up, the unnecessary region can be easily identified.

Further, the waste removal cutting (special cutting) is cutting to make a wedge-shaped cut one or more times by moving the drive axis 174c of the cutter blade 174 to change the orientation of the edge 174a of the cutter blade 174 in the state in which the cutter blade 174 of the cutter 17 is inserted in the sheet 60 (cutting target medium). Normally, when cutting is performed on a bent line that is formed of lines in different directions connected to one another, such as a wedge-shaped line, after cutting is performed on one of the lines of the wedge-shaped line from the start point to the end point, the cutter blade 174 is once evacuated from the sheet 60 and the orientation of the edge 174a of the cutter blade 174 is changed in the state in which the cutter blade 174 does not pierce the sheet 60, and then cutting is performed on the other line of the lines of the wedge-shaped line (first cutting method). Meanwhile, in the waste removal cutting, the wedge-shaped cut is made by moving the drive axis 174c of the cutter blade 174 to change the orientation of the edge 174a of the cutter blade 174 in the state in which the cutter blade 174 is inserted in the sheet 60 (the cutter blade 174 pieces the sheet 60) (second cutting method). This can bring about the turned-up appropriately.

Further, the MPU 11 sets the width (waste removal cutting width), the length (waste removal cutting length) and the position (waste removal cutting position) of the cut C for the waste removal cutting (special cutting) on the basis of the extent and the shape of the unnecessary region. This enables the waste removal cutting to be appropriately performed inside the unnecessary region.

Further, if the width WA of the inscribed quadrilateral A of the unnecessary region is greater than a reference width (waste removal cutting reference width) of the cut C for the waste removal cutting (special cutting), the MPU 11 sets the width of the cut C to the reference width of the cut C, whereas if the width WA of the inscribed quadrilateral A of the unnecessary region is equal to or less than the reference width of the cut C for the waste removal cutting (special cutting), the MPU 11 sets the width of the cut C to the width WA of the inscribed quadrilateral A. Thus, the width (waste removal cutting width) of the cut C for the waste removal cutting is set according to the width WA of the inscribed quadrilateral A of the unnecessary region. This enables the waste removal cutting to be appropriately performed inside the unnecessary region. Further, since the width (waste removal cutting width) of the cut C is set to the reference width (waste removal cutting reference width) of the cut C for the waste removal cutting when the width WA of the inscribed quadrilateral A of the unnecessary region is greater than the reference width of the cut C, the time required for the waste removal cutting can be prevented from being lengthened.

Further, if the width WA of the inscribed quadrilateral A of the unnecessary region is greater than the reference width (waste removal cutting reference width) of the cut C for the waste removal cutting (special cutting), the MPU 11 sets the position of the cut C such that one end of the width WA of the inscribed quadrilateral A and the corners of the cut C closer to the one end coincide with one another, whereas if the width WA of the inscribed quadrilateral A of the unnecessary region is equal to or less than the reference width (waste removal cutting reference width) of the cut C for the waste removal cutting (special cutting), the MPU 11 sets the position of the cut C such that all the corners of the cut C are within the width WA of the inscribed quadrilateral A. Thus, the position (waste removal cutting position) of the cut C for the waste removal cutting is set according to the width WA of the inscribed quadrilateral A of the unnecessary region. This enables the waste removal cutting to be appropriately performed inside the unnecessary region. Further, since the position of the cut C is set such that one end of the width WA of the inscribed quadrilateral A and the corners of the cut C closer to the one end coincide with one another when the width WA of the inscribed quadrilateral A of the unnecessary region is greater than the reference width (waste removal cutting reference width) of the cut C for the waste removal cutting, the turned-up can be made to occur at or near an end of the unnecessary region. This can make it easier to remove the unnecessary region as compared with the case where the turned-up is made to occur at the center of the unnecessary region.

Further, the MPU 11 sets the length of the cut C for the waste removal cutting to the height of the inscribed quadrilateral A of the unnecessary region or less. This enables the waste removal cutting to be appropriately performed inside the unnecessary region.

Further, the waste removal cutting is performed with the second cutting method different from the first cutting method in which the cutter blade 174 is moved to perform the first cutting. This can bring about the turned-up appropriately when the wedge-shaped cut is made, and accordingly the unnecessary region can be easily and smoothly removed by picking up the curls, which are generated by the turned-up, with tweezers or the like or by making the curls stand up with a finger.

Those described in the above embodiment are not limitations but mere examples of the cutting device, the cutting control method, and the storage medium storing the program (131) according to the present disclosure.

For example, the waste removal cutting (special cutting) in the above embodiment may be half cutting by which the cutting target medium is not completely cut. For example, if the cutting target medium is a sticker sheet composed of at least two layers, for example, a base material and a sticker, the waste removal cutting may be performed on only the sticker with the second cutting method. If the sticker sheet is cut with the first cutting method, both of the two layers of the base material and the sticker are completely cut.

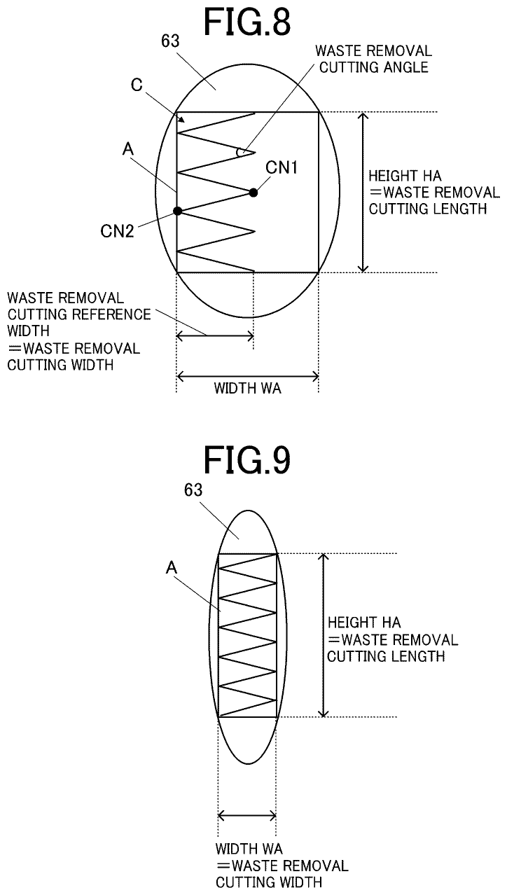

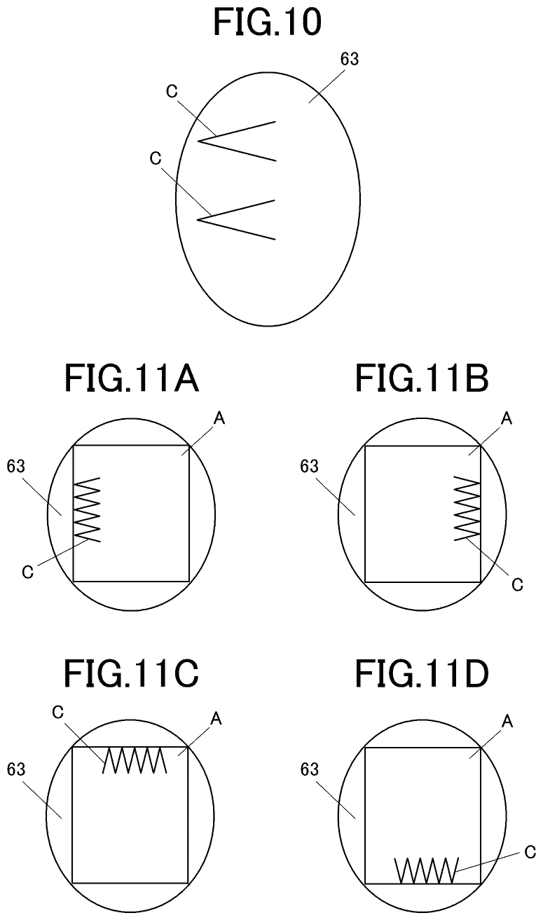

Further, in the above embodiment, the waste removal cutting is performed to form the continuous zigzag cut C (in FIG. 6), but may be performed to form two or more wedge-shaped (V-shaped) cuts C at positions apart from one another as illustrated in FIG. 10.

Further, in the above embodiment, pressures and cutting speeds at which the cutter blade 174 cuts the sheet 60 (cutting target medium) in the normal cutting and the waste removal cutting are not specified, but may be specified for the normal cutting and the waste removal cutting separately in order to bring about the turned-up appropriately. For example, the pressure and/or the cutting speed at which the cutter blade 174 cuts the sheet 60 in the waste removal cutting may be greater (or less) and/or faster (or slower) than the pressure and/or the cutting speed in the normal cutting, respectively.

Further, in Step S2 of the waste removal cutting process (in FIG. 5) in the above embodiment, the inscribed quadrilateral A may be derived such that the direction of the width WA of the inscribed quadrilateral A is along the X-axis direction or the Y-axis direction of the cutting device 10. In this case, the waste removal cutting may be performed to make the cut C along one side specified in advance from the four sides of the inscribed quadrilateral A. For example, if the left side of the four sides of the inscribed quadrilateral A is specified in advance, as illustrated in FIG. 11A, the cut C is made with the waste removal cutting position set such that the left side of the inscribed quadrilateral A and corners to be made by the waste removal cutting (corners of the cut C) closer to the left side coincide with one another. As another example, if the right side of the four sides of the inscribed quadrilateral A is specified in advance, as illustrated in FIG. 11B, the cut C is made with the waste removal cutting position set such that the right side of the inscribed quadrilateral A and corners to be made by the waste removal cutting (corners of the cut C) closer to the right side coincide with one another. As another example, if the upper side of the four sides of the inscribed quadrilateral A is specified in advance, as illustrated in FIG. 11C, the cut C is made with the waste removal cutting position set such that the upper side of the inscribed quadrilateral A and corners to be made by the waste removal cutting (corners of the cut C) closer to the upper side coincide with one another. As another example, if the lower side of the four sides of the inscribed quadrilateral A is specified in advance, as illustrated in FIG. 11D, the cut C is made with the waste removal cutting position set such that the lower side of the inscribed quadrilateral A and corners to be made by the waste removal cutting (corners of the cut C) closer to the lower side coincide with one another.

Although one or more embodiments of the present disclosure have been described above, the scope of the present disclosure is not limited to the above embodiments, but includes the scope of claims and the scope of their equivalents.

In the waste removal cutting process of the above embodiment (in FIG. 5), regardless of whether the user desires it, the waste removal cutting is automatically performed in unnecessary regions (e.g., unnecessary region 63 in FIG. 6) and the turned-up occurs accordingly. This causes a problem that unnecessary regions cannot be used for other purposes (e.g., masking). Further, if an unnecessary region is too small to perform the waste removal cutting therein, a necessary region adjacent to such an unnecessary region is affected by the waste removal cutting due to an error in the drive position of the cutter blade 174. Therefore, in a cutting data generating process (described later) for generating cutting data according to a modification, whether the waste removal cutting is required is selected for each unnecessary region, and cutting data (unnecessary region information) generated is provided with necessity identification information indicating the selection results for the respective unnecessary regions of whether the waste removal cutting is required. In the waste removal cutting process (described later) of this modification, the waste removal cutting is performed, on the basis of the necessity identification information, only inside an unnecessary region(s) requiring the waste removal cutting.

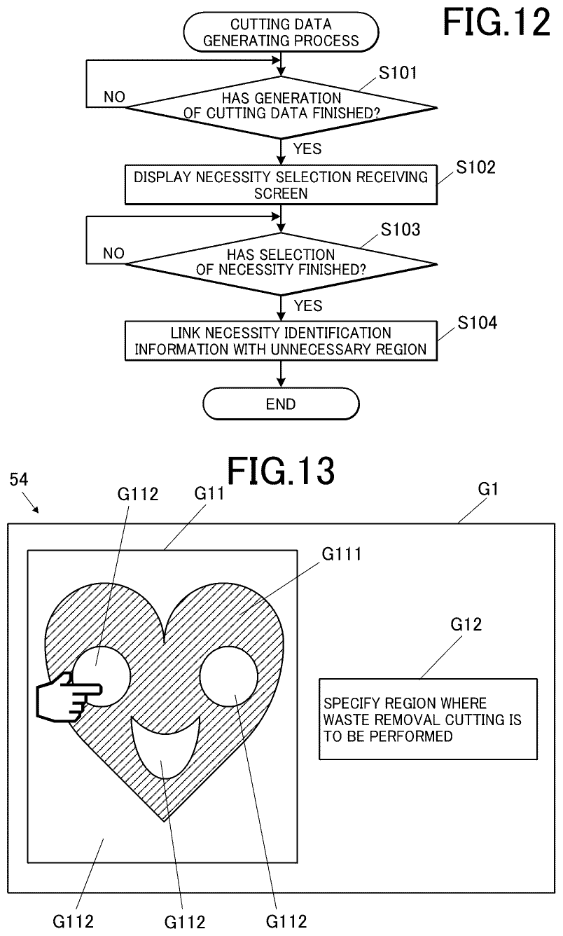

The cutting data generating process that is performed by the terminal device 50 will be described with reference to FIG. 12. When the cutting data generating process is started, the CPU 51 of the terminal device 50 generates cutting data on the basis of a user operation(s) and determines whether generation of cutting data has finished (Step S101). In Step S101, if the CPU 51 determines that generation of cutting data has not finished (Step S101; NO), the CPU 51 repeats the determination process of Step S101 until generation of cutting data finishes. If the CPU 51 determines that generation of cutting data has finished (Step S101; YES), the CPU 51 causes the display 54 to display a necessity selection receiving screen G1 to receive selections for respective unnecessary regions as to whether the waste removal cutting is required (Step S102). If cutting data is generated in advance and stored in the storage 53, the CPU 51 may cause the display 54 to display the necessity selection receiving screen G1 in response to obtaining the cutting data from the storage 53.

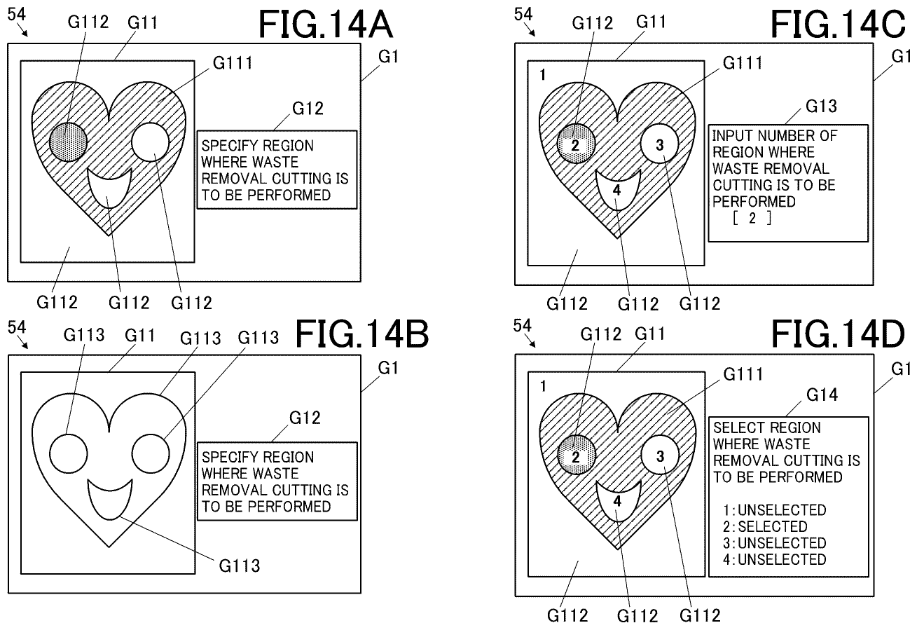

As illustrated in FIG. 13, on the necessity selection receiving screen G1, a cutting image G11 based on the generated cutting data is displayed, and also message information G12 prompting the user to select for each unnecessary region whether the waste removal cutting is required (e.g., “Specify region where waste removal cutting is to be performed”) is displayed. The cutting image G11 is displayed such that unnecessary regions G112 are distinguishable from a necessary region G111. For example, the necessary region G111 is displayed with hatched, and the unnecessary regions G112 are displayed in white (with a white background). The unnecessary regions G112 can be specified (selected) with user operations through the operation receiver 55 (e.g., touches on the unnecessary regions G112). When an operation to specify an unnecessary region G112 is made as illustrated in FIG. 13, the unnecessary region G112 is specified as a region where the waste removal cutting is to be performed (region requiring the waste removal cutting) and, as illustrated in FIG. 14A, displayed in a display mode of a predetermined display color (e.g., gray) changed from a display mode of white. On the other hand, when an operation to specify an unnecessary region G112 is made in a state in which the unnecessary region G112 is displayed in the display mode of the predetermined display color, the unnecessary region G112 is specified as a region where the waste removal cutting is not to be performed (region not requiring the waste removal cutting) and displayed in the display mode of white changed from the display mode of the predetermined display color.

On the necessity selection receiving screen G1, the necessary region G111 and the unnecessary regions G112 may be distinguishable from one another by, for example, using different display colors or different color densities. Further, when the cutting image G11 is first displayed on the necessity selection receiving screen G1, the unnecessary regions G112 may not be displayed in white but displayed in the aforementioned predetermined display color. That is, the unnecessary regions G112 may be displayed in a state in which they all are specified (selected) as the region where the waste removal cutting is to be performed. Alternatively, as illustrated in FIG. 14B, the cutting image G11 may be displayed such that only cut lines G113 to cut out the unnecessary regions G112 are displayed without the necessary region G111 and the unnecessary regions G112 distinguished from one another.

Further, the method for receiving selections for respective unnecessary regions as to whether the waste removal cutting is required is not limited to receiving the aforementioned user's direct operations on the respective unnecessary regions G112 to specify the unnecessary regions G112. For example, as illustrated in FIG. 14C, an input form G13 to input a number(s) of the region where the waste removal cutting is to be performed may be provided, and a selection(s) as to whether the waste removal cutting is required may be received by the input form G13 in which the number(s) of the region where the waste removal cutting is to be performed is input on the basis of a user operation(s). In this case, the cutting image G11 is provided with numbers (1 to 4) to identify the respective unnecessary regions G112. In the example illustrated in FIG. 14C, the unnecessary region G112 corresponding to the number “2” is specified (selected) as the region where the waste removal cutting is to be performed. Alternatively, as illustrated in FIG. 14D, a selection form G14 to select for each unnecessary region G112 whether the waste removal cutting is required may be provided, and selections as to whether the waste removal cutting is required for the respective unnecessary regions G112 may be received by the selection form G14. In this case, the cutting image G11 is provided with the numbers (1 to 4) to identify the respective unnecessary regions G112. In the example illustrated in FIG. 14D, the unnecessary region G112 corresponding to the number “2” is specified (selected) as the region where the waste removal cutting is to be performed.

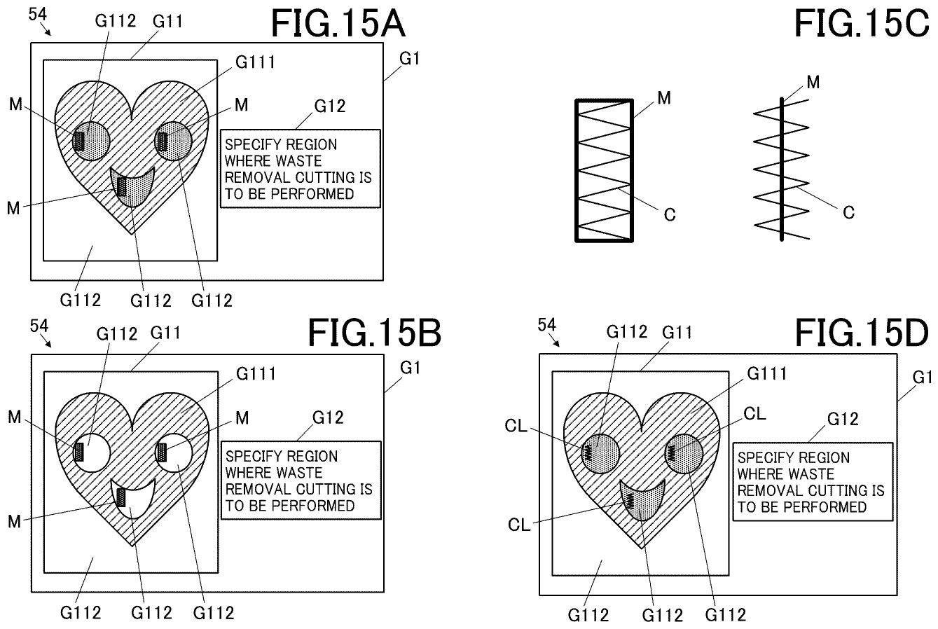

Further, on the necessity selection receiving screen G1, when an unnecessary region(s) G112 is specified (selected) as the region where the waste removal cutting is to be performed, in addition to the specified unnecessary region(s) G112 displayed in the predetermined display color, a symbol mark(s) M indicating the position where the waste removal cutting is to be performed may be displayed as illustrated in FIG. 15A. Alternatively, as illustrated in FIG. 15B, the specified unnecessary regions G112 may be displayed not in the predetermined display color but with the symbol marks M, so that the region where the waste removal cutting is to be performed can be identified, namely, is distinguishable from the region where the waste removal cutting is not to be performed. The symbol marks M each are displayed, as illustrated at the left half of FIG. 15C, in a mode of a circumscribed quadrilateral of a cut (cut C) that is actually to be made by the waste removal cutting, but may be displayed, as illustrated at the right half of FIG. 15C, in a mode of a center line of the cut (cut C) that is actually to be made by the waste removal cutting. Instead of the symbol marks M, as illustrated in FIG. 15D, cut lines CL each indicating the cut (cut C) that is actually to be made by the waste removal cutting may be displayed. In this case, the cut lines CL may be displayed in red or in a flashing manner so that the cut lines CL can be recognized easily.

Returning to FIG. 12, next, the CPU 51 determines whether selections for the respective unnecessary regions as to whether the waste removal cutting is required have finished on the necessity selection receiving screen G1 (Step S103). In Step S103, if the CPU 51 determines that selections for the respective unnecessary regions as to whether the waste removal cutting is required have not finished (Step S103; NO), the CPU 51 repeats the determination process of Step S103 until the selections finish. In Step S103, if the CPU 51 determines that selections for the respective unnecessary regions as to whether the waste removal cutting is required have finished (Step S103; YES), the CPU 51 links pieces of necessity identification information on the waste removal cutting with the respective unnecessary regions (their corresponding unnecessary regions) on the basis of the selection results for the respective unnecessary regions of whether the waste removal cutting is required received by the necessity selection receiving screen G1, thereby providing the cutting data (unnecessary region information) with the (pieces of) necessity identification information for the unnecessary regions (Step S104). Then, the CPU 51 ends the cutting data generating process. The method for providing the cutting data with the necessity identification information may be a method of attaching the necessity identification information to the cutting data itself or a method of not attaching the necessity identification information to the cutting data itself but correlating the necessity identification information with the cutting data.

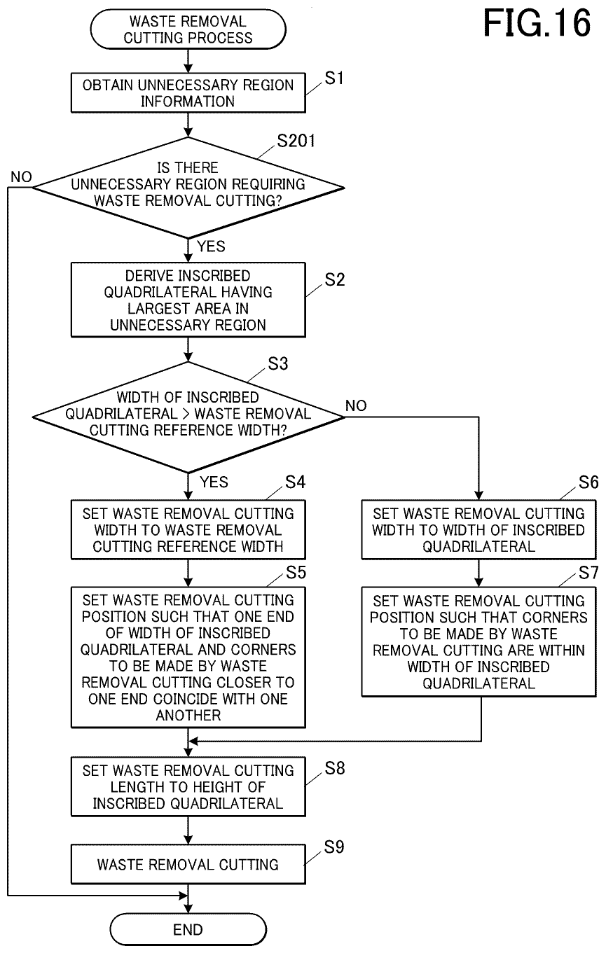

Next, the waste removal cutting process according to a modification will be described with reference to FIG. 16. When the waste removal cutting process of this modification is started, the MPU 11 obtains unnecessary region information from the cutting data (Step S1) as in the waste removal cutting process of the above embodiment (in FIG. 5). Next, on the basis of the necessity identification information with which the unnecessary region information is provided, the MPU 11 determines whether there is an unnecessary region(s) requiring the waste removal cutting (Step S201). In Step S201, if the MPU 11 determines that there is no unnecessary region requiring the waste removal cutting (Step S201; NO), the MPU 11 ends the waste removal cutting process. In Step S201, if the MPU 11 determines that there is an unnecessary region(s) requiring the waste removal cutting (Step S201; YES), the MPU 11 performs the processes of Step S2 and the subsequent steps on the unnecessary region requiring the waste removal cutting, and then ends the waste removal cutting process. The processes of Step S2 and the subsequent steps are the same as those of the waste removal cutting process in the above embodiment, and therefore descriptions thereof will be omitted.

As described above, according to this modification, the CPU 51 of the terminal device 50 causes the display 54 to display unnecessary regions (cutting image G11) of the sheet 60 (cutting target medium) that has been cut by the cutting device 10 on the basis of predetermined cutting data as the first cutting. Further, the CPU 51 receives, from the user, selections for the respective unnecessary regions (cutting image G11) displayed by/on the display 54 as to whether the waste removal cutting (special cutting), which is performed by the cutting device 10 to bring about the turned-up inside the unnecessary regions, is required. Further, the CPU 51 provides the cutting data with the (pieces of) necessity identification information indicating the received selection results of whether the waste removal cutting is required. Thus, after the first cutting is performed by the cutting device 10, the waste removal cutting is performed only inside an unnecessary region(s) where the user desires that the waste removal cutting is to be performed. Thus, the waste removal cutting can be performed flexibly.

Further, in response to receiving selections for the respective unnecessary regions as to whether the waste removal cutting is required, the CPU 51 causes the display 54 to display the unnecessary region requiring the waste removal cutting in a mode by which the user can identify the unnecessary region requiring the waste removal cutting. This allows the user to check in advance the unnecessary region where the waste removal cutting is to be performed and accordingly can prevent an unnecessary region(s) where the user does not desire that the waste removal cutting is to be performed from being subjected to the waste removal cutting.

Further, in response to receiving selections for the respective unnecessary regions as to whether the waste removal cutting is required, the CPU 51 causes the display 54 to display a predetermined mark (symbol mark M) at the position where the waste removal cutting is to be performed in the unnecessary region requiring the waste removal cutting. This allows the user to check in advance the unnecessary region where the waste removal cutting is to be performed and to easily visualize the position where the waste removal cutting is actually to be performed.

Although one or more modifications of the present disclosure have been described above, the scope of the present disclosure is not limited to the above modifications, but includes the scope of claims and the scope of their equivalents.

1. A cutting control method that is performed by a cutting device including a cutter that cuts a cutting target medium with a cutter blade based on predetermined design information, the cutting control method comprising:
in response to the design information including unnecessary region information indicating an unnecessary region to be removed after a first cutting in which the cutter blade cuts the cutting target medium based on the predetermined design information, controlling the cutter to perform special cutting inside the unnecessary region,
wherein the special cutting is performed with a second cutting method different from a first cutting method in which the cutter blade is moved to perform the first cutting.

2. The cutting control method according to claim 1, wherein the special cutting is cutting by which a wedge-shaped cut is made one or more times inside the unnecessary region.

3. The cutting control method according to claim 1,
wherein the first cutting method is a cutting method of, in cutting on a bent line that is formed of lines in different directions connected to one another, cutting on one of the lines of the bent line from a start point to an end point thereof, evacuating the cutter blade from the cutting target medium, changing an orientation of the cutter blade, and starting to cut on other of the lines of the bent line, and
wherein the second cutting method is a cutting method of, in cutting on the bent line, cutting on the one of the lines of the bent line from the start point to the end point thereof, and starting to cut on the other of the lines of the bent line without evacuating the cutter blade from the cutting target medium.

4. The cutting control method according to claim 1,
wherein the cutting target medium has a two-layer structure of two layers stacked,
wherein the first cutting method is a cutting method of completely cutting both of the two layers of the cutting target medium, and
wherein the second cutting method is a half-cutting method of not completely cutting one of the two layers of the cutting target medium.

5. The cutting control method according to claim 1, wherein the first cutting method and the second cutting method are different in pressure at which the cutter blade cuts the cutting target medium.

6. The cutting control method according to claim 1, wherein the first cutting method and the second cutting method are different in speed at which the cutter blade cuts the cutting target medium.

7. A cutting device comprising:
a cutter that cuts a cutting target medium with a cutter blade based on predetermined design information; and
a processor that in response to the design information including unnecessary region information indicating an unnecessary region to be removed after a first cutting in which the cutter blade cuts the cutting target medium based on the predetermined design information, controls the cutter to perform special cutting inside the unnecessary region,
wherein the special cutting is performed with a second cutting method different from a first cutting method in which the cutter blade is moved to perform the first cutting.

8. A non-transitory computer-readable storage medium storing a program causing, of a cutting device including a cutter that cuts a cutting target medium with a cutter blade based on predetermined design information, a computer to:
in response to the design information including unnecessary region information indicating an unnecessary region to be removed after a first cutting in which the cutter blade cuts the cutting target medium based on the predetermined design information, control the cutter to perform special cutting inside the unnecessary region,
wherein the special cutting is performed with a second cutting method different from a first cutting method in which the cutter blade is moved to perform the first cutting.
